(19) United States
(12) Patent Application Publication
(10) Pub. No.: US 2026/0336748 A1
(43) Pub. Date: Oct. 29, 2026

(54) PARKING-BRAKE DEVICE FOR CYCLES AND MOTORCYCLES, IN PARTICULAR FOR ELECTRIC BICYCLES

(71) Applicant: Blubrake S.p.A., Milano (IT)

(72) Inventors: Daniele BERRETTA, Milano (IT); Andrea VERZAGLIA, Milano (IT); Fabio TODESCHINI, Milano (IT)

(73) Assignee: Blubrake S.p.A., Milano (IT)

(21) Appl. No.: 19/484,233

(22) PCT Filed: May 13, 2024
(86) PCT No.: PCT/IB2024/054648

§ 371 Date: Nov. 13, 2025

(30) Foreign Application Priority Data
May 29, 2023 (IT) 102023000010833

(51) Int. Cl. B62L 3/02; B60T 8/32

(52) U.S. Cl. CPC B62L 3/023; B60T 8/3225

(57) ABSTRACT

A parking-brake device for a hydraulic braking system for electric bicycles, includes a valve unit having a valve body with an inlet and an outlet. A valve member is movable within the valve body between an open position,, and a closed position,. The movable member of the valve unit is actuated by an electric-actuator device, for a displacement from the open position to the closed position and for a displacement from the closed position to the open position, the closed position and the open position being stable positions in which the movable member remains when the electric-actuator device is deactivated.

### FIELD OF THE INVENTION

The present invention relates to a parking-brake device, for a hydraulic braking system for cycles and motorcycles, in particular for electric bicycles, of the type in which the braking system includes:
a brake device associated to a wheel of the vehicle;
a hydraulic cylinder for actuating the brake device, associated to the brake device; and
a master hydraulic cylinder associated to a brake lever, configured for supplying pressurized fluid, via a connection line, to the hydraulic cylinder for actuating the brake device, following upon an activation of the brake lever,
   wherein the parking-brake device includes a valve unit interposed in the line of connection between the master hydraulic cylinder and the cylinder for actuating the brake; and
   wherein said valve unit comprises:
a valve body with an inlet for receiving pressurized fluid coming from the master cylinder and an outlet for sending pressurized fluid to the cylinder for actuating the brake device; and
a valve member movable within the valve body between an open position, where the inlet communicates with the outlet, and a closed position, where the communication between the inlet and the outlet is interrupted.

### PRIOR ART

A parking-brake device of the type referred to above is, for example, described in the document FR 3 013 307 B1. In this known solution, the movable member of the valve unit is manually movable between its open position and its closed position by means of a lock device that can be actuated with the use of a key.

Moreover known from the document US 2020/398802 A1 is an ABS device for hydraulic braking systems for electric bicycles including an electrically actuated valve for opening or closing a hydraulic connection between a master cylinder associated to a brake lever and an actuator cylinder associated to a disk-brake caliper. This solution does not regard a parking brake.

### OBJECT OF THE INVENTION

The object of the present invention is to provide a parking-brake device of an improved type, which will enable an automated actuation of the parking-brake device, without, however, entailing any major expenditure of energy.

A further object of the invention is to provide a parking-brake device of the type referred to above that will be extremely reliable and efficient, but at the same time simple and inexpensive.

A further object of the invention is to provide a parking-brake device that can be actuated in an extremely simple and functional way by the user.

### SUMMARY OF THE INVENTION

With a view to achieving one or more of said objects, the subject of the invention is a parking-brake device having the characteristics referred to at the start of the present description and further characterized in that said movable member of the valve unit is actuated, not via fluid pressure, by an electric-actuator device, both for a displacement from the open position to the closed position and for a displacement from the closed position to the open position, the open position and the closed position both being stable positions in which the movable member remains when the electric-actuator device is deactivated.

In a preferred embodiment, the parking-brake device according to the invention is characterized in that it further comprises:
a sensor associated to said valve unit and configured for detecting the position of the movable member; and
an electronic controller, for controlling said electric-actuator device, configured for receiving a signal indicating the position of the movable member from said sensor and for controlling a displacement of the movable member from said open position to said closed position or from said closed position to said open position, following upon a control signal imparted by a user.

Preferably, the electronic controller is configured for detecting an active condition of the brake device and for enabling a displacement of said movable member from the open position to the closed position only when the brake device is in an active condition.

In use, in order to activate the parking-brake device, the user, once he or she has stopped the vehicle (for example, an electric bicycle), actuates the brake device via the brake lever and, in this condition, imparts a command to the electronic controller in order to displace the movable member of the valve unit from the open position to the closed position. In this condition, the hydraulic line on the side of the cylinder for actuating the brake device is isolated from the hydraulic line on the side of the brake lever. Consequently, the brake device (for example, a disk-brake caliper) remains blocked in the braking condition.

In a particularly preferred embodiment, the electronic controller is configured to actuate said electric-actuator device following upon a control signal issued to the electronic controller by a user via a remote server, which the user can access via a dedicated application on a smartphone, tablet, or other portable electronic device.

The user, to activate the parking-brake device, merely has to actuate the brake lever and, maintaining this condition, govern application of the parking-brake device by means of his or her own portable electronic device.

Not excluded, however, is the possibility of providing a human-machine-interface device, associated to the valve unit, which will enable the user to govern displacement of the movable member of the valve unit, and not excluded either is the possibility of providing a mechanical-actuation device, for example one that can be actuated using a key, which can serve as back-up in the event of failure of the electric-actuator device.

It may be envisaged that the system will comprise a pressure sensor associated to the brake device and that said electronic controller will be configured for receiving a signal from said pressure sensor in such a way as to detect an active or inactive condition of the brake device. As an alternative or in addition to this characteristic, it may be envisaged that the system will comprise a sensor for detecting the angular velocity of the wheel to which the brake device is associated and that the electronic controller will be configured for enabling displacement of the movable member of said valve unit from the open position to the closed position only when a stationary condition of the wheel is detected.

According to a further preferred characteristic, the system may comprise a sensor for detecting the position of the vehicle, for example a GPS sensor, and the electronic controller may be configured for receiving a signal from said vehicle-position sensor.

Preferably, associated to the electronic controller is a communication module for communicating with a remote server. In this way, the electronic controller of the system can communicate to said remote server an active/inactive condition of the brake device and the position of the vehicle, which may enable the user, after he or she has left the vehicle in the parking condition with the parking-brake device activated, to control remotely the condition and position of the vehicle.

It may also be envisaged that the system activates an acoustic-alarm signal in the case where the electronic controller detects an anomalous condition as likely indication of theft, such as a drop in pressure in the cylinder for actuating the brake caliper, or a movement of the vehicle, or a rotation of the wheel. In the case of remote control via a portable electronic device such as a smartphone or tablet, the alarm signal can be activated on the remote-control device.

According to a further variant, in the case of application to a power-assisted bicycle, it may be envisaged that, when said anomalous situation is detected as likely indication of theft, the electronic controller will disable the power-assist function provided by the electric motor of the bicycle.

The system may be configured for a vehicle that includes a hydraulic ABS-actuator device set between the master cylinder associated to the brake lever and the cylinder for actuating the brake device. In this case, the valve unit of the parking-brake device is set between the ABS device and the cylinder for actuating the brake device (typically a disk-brake caliper). The electronic controller of the system may be a dedicated stand-alone electronic controller, or else, in the case of use of an ABS-actuator device provided with an electronic control unit of its own, may coincide with the latter.

In a concrete embodiment, the movable member of the valve unit of the parking-brake device is a slide valve mounted in a cylindrical cavity of the body of the valve unit and carrying at least one seal ring that, in the closed position, engages the wall of said cavity in such a way as to isolate the outlet of the valve unit with respect to the inlet of the valve unit, without any variation of the volume in the line that communicates with the cylinder for actuating the brake device so that displacement of the movable member from the open position to the closed position is not countered by any increase in pressure, which minimizes the energy necessary for bringing about movement of the sliding spool. There may likewise be envisaged any other configuration suitable for enabling minimization of the force necessary for displacing the movable member of the valve.

In the above example of embodiment, associated to the spool is a further elastically deformable seal ring configured for co-operating selectively with two different seats provided in the cavity of the body of the valve unit, respectively, in the open position and in the closed position so as to render stable the position of the spool after each activation, whether the spool is in the open position or in the closed position.

The position sensor may, for example, be a capacitive sensor, having an annular body provided within the cavity of the body of the valve unit and designed to receive inside it a portion of the spool when the latter moves into its closed position.

The electric-actuator device that brings about displacement of the spool may, for example, be an electric motor that governs movement of the spool by means of a screw-and-nut system, or else may comprise a first solenoid and a second solenoid configured and arranged, respectively, for bringing about displacement of the spool in one direction, from the open position to the closed position, and in the opposite direction, from the closed position to the open position. There may also be envisaged a single solenoid in combination with a mechanism that enables displacement of the movable member in one direction or in the other at each new activation of the solenoid (like the mechanisms provided for retractable ballpoint pens).

The invention is of general application on cycles and motorcycles but is of particular interest for electric bicycles and even more for electric bicycles of the cargo type, the relatively heavy weight of which renders the use of a parking-brake device particularly advantageous, above all when the bicycle is left on a slope.

### DETAILED DESCRIPTION OF THE INVENTION

Further characteristics of the invention will emerge from the ensuing description with reference to the annexed drawings, which are provided purely by way of non-limiting example, and in which:

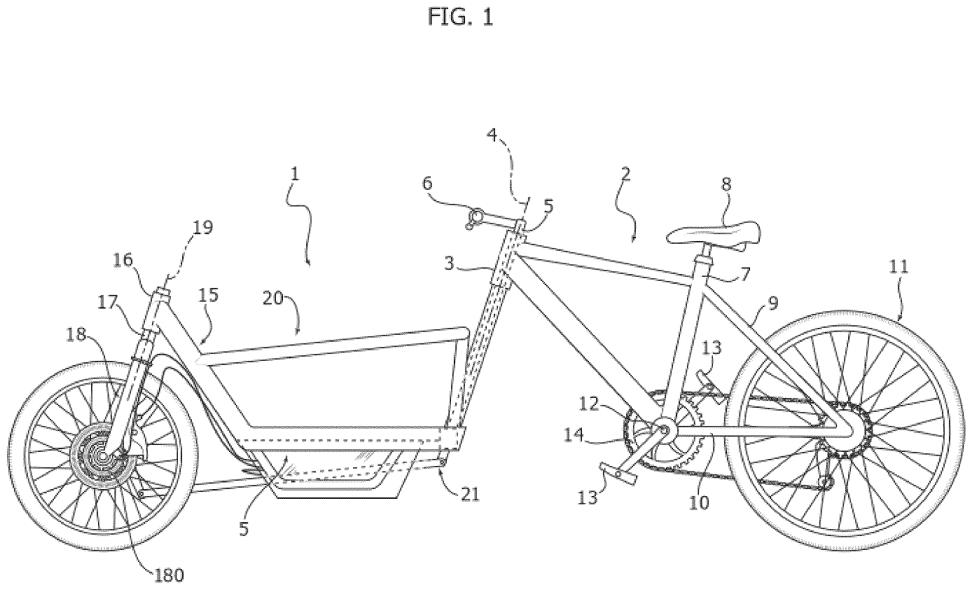

FIG. 1 is a side view that illustrates an example of an electric cargo bicycle to which the system according to the invention may be applied;

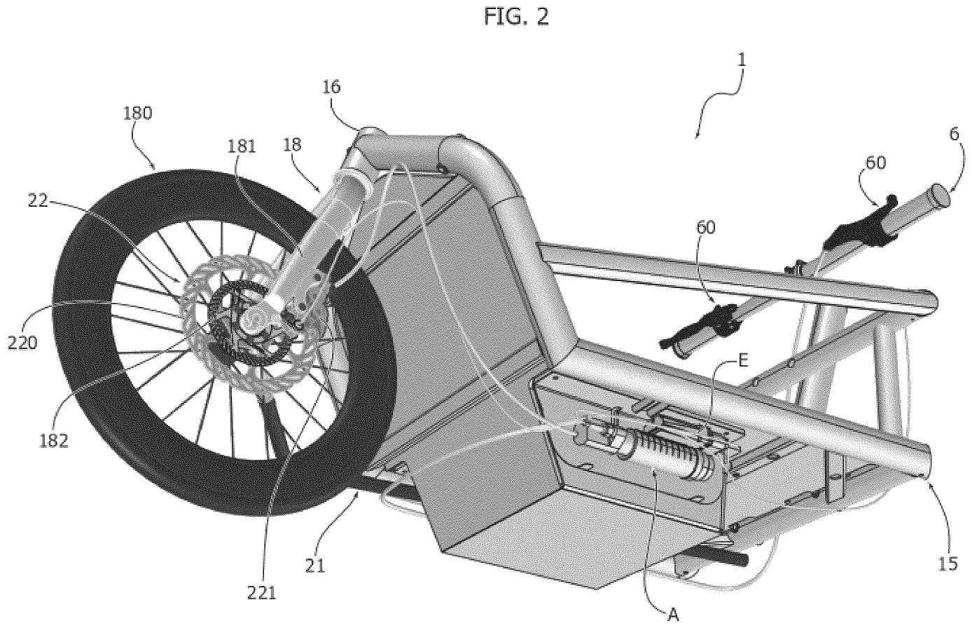

FIG. 2 is a perspective view of a detail of the electric cargo bicycle of FIG. 1;

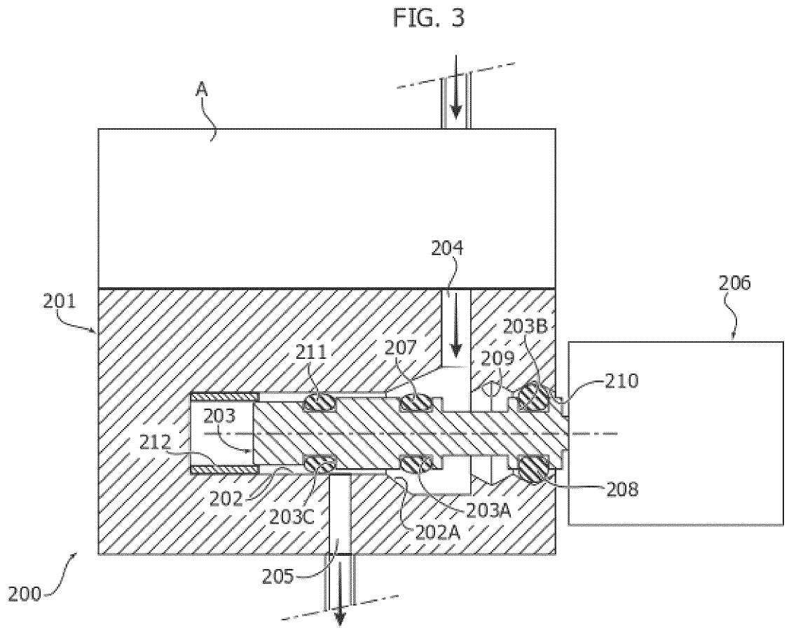

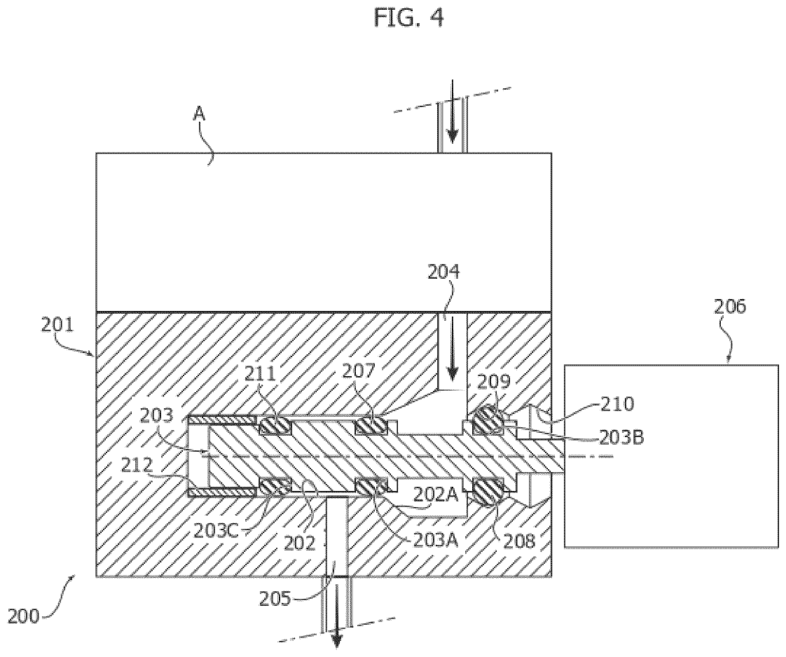

FIGS. 3 and 4 are schematic representations of the valve unit of the system according to the invention, respectively, in the open condition and in the closed condition;

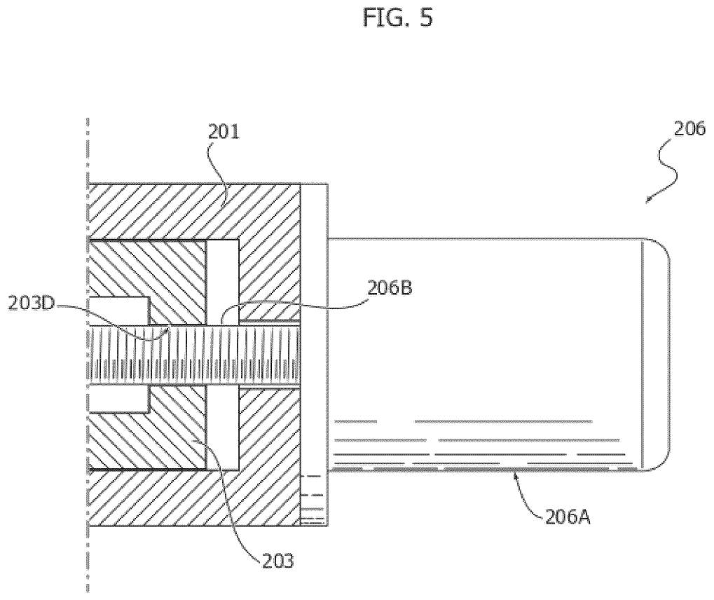

FIG. 5 shows an example of electric-actuator device that can be used in the system according to the invention; and

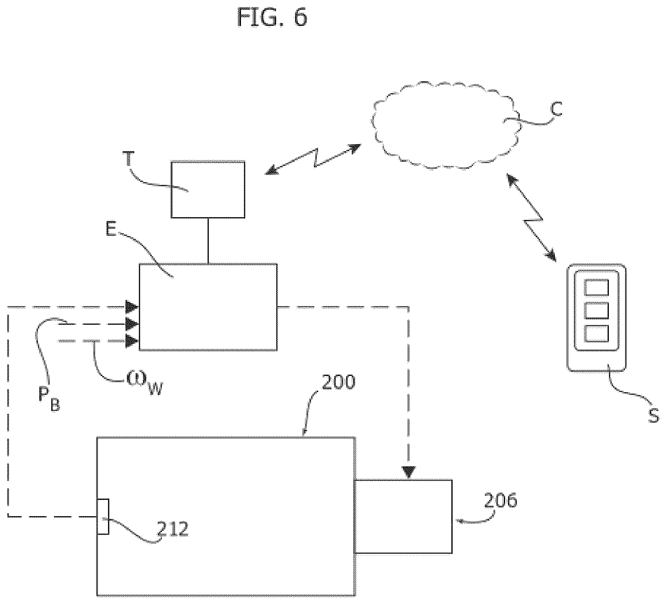

FIG. 6 is a schematic illustration of an example of embodiment of the system according to the invention.

Purely by way of example, FIG. 1 shows an electric bicycle 1 of the cargo type to which the system according to the invention may be applied. It is evident, however, that the system according to the invention is of general application and may in particular be applied to electric bicycles of any type or also to motorcycles and scooters. In the present description and in the ensuing claims, the expression “electric bicycles” regards in particular electric power-assisted bicycles.

In FIG. 1, the reference number 1 designates as a whole an example of cargo bicycle of the type that formed the subject of the patent application No. WO 2022/097054 A1 filed in the name of the present applicant. In this example, the bicycle 1 comprises a bicycle frame 2 constituted, for example, by tubular elements welded together. The frame 2 includes a head tube 3 that supports, rotatably about an axis 4, a steering shaft 5 of a handlebar 6. According to the conventional art, the frame 2 moreover includes: a seat tube 7, rigidly blocked within which is the seat post for supporting a saddle 8; rear forks 9, that support in rotation a rear-wheel unit 11; and a crank axle 12 connected to the crank levers that carry respective pedals 13. Once again according to the conventional art, the crank axle 12 carries a front crank wheel 14 connected, by means of a chain transmission, to a rear sprocket associated to the pin of the rear wheel 11. Of course, the cargo bicycle 1 may also be provided with a gear-change device of any known type, for selectively engaging the transmission chain on one of a series of rear sprockets and/or on one of a series of front sprockets.

According to a typical configuration of cargo bicycles of this type, the frame 2 moreover includes a front frame prolongation, designated as a whole by the reference number 15, which includes a front-fork tube 16, rotatably mounted within which is the column or shaft 17 of a front fork 18 that supports in rotation the front-wheel unit 180, which may be either single-wheeled or double-wheeled. The axis of rotation 19 of the column 17 of the front fork 18 is set at a considerable distance forward with respect to the axis of rotation 4 of the handlebar 6. The front prolongation 15 of the frame is used for supporting a luggage or baggage rack or carrier 20. Finally, a steering linkage 21 connects the shaft 5 of the handlebar 6 to the front fork 18 in order to transmit rotation of the handlebar to the front fork 18.

With reference also to FIG. 2, the cargo bicycle illustrated herein is provided with a front hydraulic braking system that includes a front disk brake 22, which in turn includes a disk 220 associated to the front wheel and a disk-brake caliper 221 that is carried by an arm 181 of the fork 18 and co-operates with the disk 220. In a way in itself known, the disk-brake caliper 221 includes a hydraulic actuator cylinder (not illustrated) that can be actuated by means of a front brake lever 60, which, in the example illustrated in FIG. 2, is associated to the handlebar 6. Once again in a way in itself known, associated to the brake lever 60 is a master hydraulic cylinder (not illustrated), which is connected hydraulically, by means of flexible tubings, to the brake caliper 221. The constructional details of the disk brake 22, of the brake lever 60, of the master cylinder associated to the brake lever, and of the cylinder for actuating the disk brake are not described or illustrated herein in so far as they can be obtained in any known way.

In the example illustrated in FIG. 2, set between the master cylinder associated to the brake lever 60 and the cylinder for actuating the brake caliper 221 is an ABS-actuator device, denoted by A in FIG. 2. Associated to the hydraulic ABS-actuator device A is an electronic control unit E, which is able to control activation of the device A when a condition of incipient blocking of the front wheel during braking is detected. For this purpose, the bicycle is provided with one or more sensors designed to detect a condition of incipient blocking of the front wheel during braking. In a way in itself known, said sensors may comprise, for example, a sensor for detecting the velocity of rotation of the front wheel, which is carried by the fork arm 181 and co-operates with a phonic wheel 182 associated to the front wheel, and/or, for example, a sensor for detecting the vertical load on the rear wheel, which is designed to detect when this load drops below a threshold value indicative of a tendency of the bicycle to buck and turn over about the axis of the front wheel.

When the electronic unit E detects a condition of danger during braking on the basis of the signal sent by one or more of the sensors described above, it activates the ABS-actuator device A, which causes a reduction in the pressure of the fluid supplied to the brake caliper. The details of construction of the actuator device A are not described or illustrated herein in so far as they can be obtained in any known way. It should moreover be considered that the present invention may be applied also in the case where the ABS-actuator device is not envisaged.

To come now to the parking-brake device that forms the subject of the invention, said device comprises a valve unit 200 (see FIGS. 3 and 4), which is interposed in the line of connection between the master cylinder associated to the brake lever and the cylinder for actuating the brake device (in the example illustrated, the cylinder for actuating the caliper of the disk brake). The valve unit 200 has a body 201, which, in the example illustrated, has a cylindrical cavity 202, slidably mounted within which is a movable member 203 configured like the spool of a slide valve. FIGS. 3 and 4 refer to the case where an ABS-actuator device A is provided. In this case, the valve unit 200 is hydraulically installed in the line that connects the ABS-actuator device A and the cylinder for actuating the brake caliper. The body 201 defines an inlet 204 for receiving pressurized fluid coming from the brake lever, via the ABS-actuator device A, and an outlet 205 for supplying pressurized fluid to the cylinder for actuating the brake caliper.

In the case where the ABS-actuator device A is not provided, the inlet 204 receives pressurized fluid directly from the master cylinder associated to the brake lever.

The movable member 203 of the valve unit 200 is movable via an electric-actuator device 206 between an open position (FIG. 3), where the inlet 204 communicates with the outlet 205, and a closed position (FIG. 4), where the outlet 205 is isolated from the inlet 204.

In the example illustrated, the movable member 203 has a cylindrical body carrying a rubber seal ring 207, which is elastically deformable and, in the open position illustrated in FIG. 3, is set at a distance from a widened portion 202A of the cavity 202 so that it enables free communication between the inlet 204 and the outlet 205. In the closed position, instead, the seal ring 207 engages with a portion of smaller diameter of the cavity 202 so as to isolate the outlet 205 from the inlet 204.

In the example illustrated, the seal ring 207, when it is in its non-deformed condition, has an outer diameter larger than the diameter of the portion of smaller diameter of the cavity 202. In this way, in the closed position illustrated in FIG. 4, the seal ring 207 is compressed radially, which ensures a sealing contact between the ring 207 and the wall of the cavity 202.

As illustrated in the drawings, the seal ring 207 is received and blocked within a circumferential groove 203A of the movable member 203.

The movable member 203 is moreover provided with a further seal ring 208, which is also made of rubber and is elastically deformable in a radial direction. The seal ring 208 is received in a circumferential groove 203B of the movable member 203.

The seal ring 208 is configured for co-operating selectively with two seats 209, 210 of the cavity 202, respectively in the closed position and in the open position, so as to render stable each of these positions. To displace the movable member 203 from either of these positions it is sufficient to exert a minimal force such as to bring about exit of the seal ring 208 from the respective seat via deformation thereof in a radial direction.

Adjacent to the end of the movable member 203 that is located on the side opposite to the electric-actuator device 206, the movable member carries a further seal ring 211 made of rubber, which is also blocked within a circumferential groove 203C of the movable member 203. The seal ring 211 has the purpose of separating the environment traversed by the fluid for actuation of the brake caliper with respect to one end of the cavity 202, where a position sensor 212 is set, which, in the example, is a capacitive position sensor that has a tubular body set within the cavity 202 and is designed to receive inside it an end portion of the movable member 203 when the latter is in the closed position. The sensor 212 is configured for detecting the position of the movable member 203 and communicating it to an electronic controller E, which may be the same electronic controller as that of the ABS-actuator device A, in the case where the latter device is provided, or alternatively may be a dedicated electronic controller (see FIG. 6).

With reference once again to FIG. 3, when the valve unit 200 is in the open position illustrated therein, the inlet 204 of the valve unit 200 communicates with the outlet 205 so that the braking system of the bicycle can be used in the normal way; during use of the bicycle, actuation of the brake lever 60 brings about supply of pressurized fluid through the valve unit 200 as far as the cylinder for actuating the brake caliper.

When the user wishes to activate the parking-brake device, once the bicycle has been parked, he or she must first of all actuate the brake lever 60 for controlling activation of the brake caliper and, in this condition, govern displacement of the movable member of the valve unit 200 from the open position to the closed position illustrated in FIG. 4. In this condition, the outlet 205, and therewith the entire hydraulic line on the side of the brake caliper, is isolated from the inlet 204 that communicates with the side of the brake lever. Consequently, in this condition, the brake caliper is blocked in the closed condition.

As is evident from FIGS. 3 and 4, displacement of the movable member 203 from the open position to the closed position does not cause any variation of volume in the line on the side of the brake caliper so that this displacement occurs without having to overcome any hydraulic pressure, and this consequently leads to a minimal expenditure in terms of energy.

According to the invention, the actuator device 206 of the movable member 203 is an electric-actuator device that is able to actuate the movable member 203, not by fluid pressure, but by direct effect of the actuator device 206.

With reference to FIG. 5, the actuator device 206 may, for example, be an electric motor 206A, which brings about axial displacement of the movable member 203 by means of a screw-and-nut system, which includes a screw 206B that is driven in rotation by the motor and is engaged through a threaded hole 203D formed in a portion of the movable member 203, which is guided within the cavity 202 in such a way as to be prevented from rotating about its own axis.

Alternatively, the actuator device 206 may, for example, comprise two solenoids (not illustrated), which are configured for governing axial displacement of the movable member 203 in one direction and in the other, respectively. Alternatively, once again there may be provided a single solenoid in combination with a mechanism that enables displacement of the movable member in one direction or in the other at each new activation of the solenoid.

The constructional details of each of the above solutions are not illustrated herein in so far as they can be obtained in any known way.

With reference to FIG. 6, in one example of embodiment, associated to the electronic controller E is a communication module T configured for communicating with a remote server C. In order to activate the parking-brake device, the user can employ a dedicated application on a portable electronic device, for example a smartphone S configured for communicating with a remote server C, which in turn communicates with the transmission module T associated to the electronic controller E. Once the bicycle has been parked, the user must actuate the brake lever 60 to activate the brake caliper and, in this condition, via the dedicated application on his or her smartphone S, can enable activation of the parking-brake device. The command received by the remote server C is sent by the remote server to the electronic controller E, which brings about intervention of the electric-actuator device 206. Conversely, when it is necessary to release the parking-brake device, the user, once again using an application on his or her smartphone S, can control deactivation of the parking-brake device.

Once again with reference to FIG. 6, the controller E may be configured so as not to enable activation of the parking-brake device if it detects (via a sensor for detecting a pressure pB associated to the brake caliper) that the brake caliper is not blocked or if it detects that the wheel to which the brake device is associated is moving (by means of a sensor for detecting the velocity of rotation ww of the wheel).

It may also be envisaged that the system will comprise a sensor for detecting the position of the vehicle, for example of the GPS type, which can communicate to the remote server C the position of the vehicle.

Thanks to said characteristics, once the bicycle has been parked, with the parking-brake device activated, the user can in any case control the state and position of the bicycle remotely by means of his or her portable electronic device.

In the case where the vehicle remains parked for a long time with the brake device activated, it may occur that, on account of leakage of fluid through the seal rings, the pressure on the side of the brake caliper decreases. Following upon detection of said drop in pressure indicated by the pressure sensor associated to the brake caliper, the electronic controller may be configured for generating a notification, via the communication module, to the remote server, which consequently generates information for the user regarding the risk of an imminent release of the brake on the wheel, with loss both of the antitheft function and of the parking-brake function. It may also be envisaged to notify the user of, and carry out, deactivation of the parking-brake device after a given time.

If the parking-brake device remains activated for a prolonged period, this may also lead to the risk of degradation of the charge of the electric battery of the vehicle, with consequent impossibility of deactivating the parking-brake device (except where a manual brake-release device is provided, governed using a key, as already referred to above). To overcome this drawback, it may also be envisaged that the electronic controller is configured for notifying the user that the parking-brake device may be deactivated electronically within a limited period of time and/or that the system will automatically deactivate the parking/antitheft functions after a given time interval. For the same reasons, in the case of absence of a manual brake-release device, it may be envisaged that activation of the parking-brake device can occur only if the state of charge of the battery is sufficient to guarantee that the device can be deactivated after a minimum preset time.

Of course, without prejudice to the principle of the invention, the details of construction and the embodiments may vary widely with respect to what has been described and illustrated herein purely by way of example, without thereby departing from the scope of the present invention.

1. Parking brake device for a hydraulic braking system for electric bicycles,
in which the hydraulic braking system comprises:
a brake device associated with a wheel of the vehicle,
a brake device actuating hydraulic cylinder, associated with the brake device, for actuating the brake device,
a master hydraulic cylinder associated with a brake lever, configured for feeding pressurized fluid, via a connecting line, to the brake device actuating hydraulic cylinder, following an activation of the brake lever,
wherein said parking brake device includes a valve unit interposed in the connection line between the master hydraulic cylinder and the brake device actuating cylinder,
wherein said valve unit (200) includes:
a valve body having an inlet for receiving pressurized fluid, directly or indirectly, from the master cylinder and an outlet for feeding pressurized fluid, directly or indirectly, to the brake device actuating cylinder,
a valve member movable within the valve body between an open position, in which the inlet communicates with the outlet, and a closed position, in which the communication between the inlet (204) and the outlet is interrupted,
wherein the movement of the movable member of the valve unit from the open position to the closed position and from the closed position to the open position is actuated by an electric actuator device, said closed position and said open position being both stable positions, in which the movable member remains when the electric actuator device (206) is deactivated.

2. Device according to claim 1, further comprising:
a sensor associated with said valve unit and configured to detect the position of the movable member, and
an electronic controller (E) for controlling said electric actuator device and configured to receive a signal indicative of the position of the movable member from said sensor and to control a displacement of the movable member from said open position to said closed position and from said closed position to said open position as a result of a control signal imparted by a user.

3. Device according to claim 2, wherein the electronic controller (E) is configured for detecting an active condition of the brake device and to enable a displacement of said movable member from the open position to the closed position only when the brake device is in an active condition.

4. Device according to claim 3, further comprising a pressure sensor (pB) associated with the brake device and said electronic controller (E) is configured for receiving a signal from said pressure sensor so as to detect an active or inactive condition of the brake device.

5. Device according to claim 3, further comprising a sensor for detecting the vehicle position, and said electronic controller (E) is configured for receiving a signal from said sensor of the vehicle position.

6. Device according to claim 3, further comprising a sensor (ωW) for detecting the angular velocity of the wheel to which the brake device is associated, and said electronic controller is configured to enable a displacement of said movable member from the open position to the closed position only when a stationary condition of the wheel is detected.

7. Device according to claim 3, wherein said electronic controller (E) is associated with a communication module (T) for communicating with a remote server (C) and said electronic controller is configured to communicate an active/deactivated condition of the brake device and/or the position of the vehicle to said remote server.

8. Device according to claim 2, wherein the electronic controller (E) is configured to actuate said electric actuator device as a result of a command signal given to said electronic controller (E) by a user via a remote server (C) which the user can access via a dedicated application on a smartphone, tablet or other portable electronic device (S).

9. Device according to claim 1, wherein the movable member is a spool slidable in a cylindrical cavity of the body of the valve unit and bearing at least one sealing ring which in the closed position engages the wall of said cavity so as to isolate the outlet of the valve unit from the inlet of the valve unit, without any change in volume in the line communicating with said actuating cylinder of the brake device, so that the displacement of the movable member from the open position to the closed position is not counteracted by any increase in pressure.

10. Device according to claim 9, wherein said movable member carries an additional sealing ring configured to selectively cooperate with two seats (209, 210) in the open position and in the closed position of the movable member to stably maintain the movable member in each of said positions.

11. Device according to claim 1, wherein the parking brake device is configured for a vehicle including a hydraulic ABS actuator device interposed between the master cylinder of the brake lever and the actuating cylinder of the brake device, said valve unit being arranged to be interposed between the ABS actuator device and the brake device.

12. Device according to claim 11, wherein the electronic controller is either an electronic controller associated with the ABS actuator device or is a stand-alone electronic controller.

13. Device according to claim 1, wherein the electric actuator device includes an electric motor operatively connected to the movable member by a screw-and-nut system.

14. Device according to claim 1, wherein the electric actuator device includes first and second solenoids configured respectively to cause an axial displacement of the movable member in one direction, from the open position to the closed position, and in the opposite direction, from the closed position to the open position.

15. Device according to claim 2, wherein the position sensor configured to detect the position of the movable member is a capacitive sensor, having an annular body disposed within the cavity of the valve body within which the movable member is movable and configured for receiving therewithin a portion of the movable member when the movable member is in an end position thereof.

16. Device according to claim 2 wherein the electronic controller (E) is configured for detecting an active condition of the brake device and to enable a displacement of said movable member from the open position to the closed position only when the brake device is in an active condition and when the vehicle is stationary.
